(19) United States
(12) Patent Application Publication
(10) Pub. No.: US 2014/0089083 A1
(43) Pub. Date: Mar. 27, 2014

(54) METHOD AND APPARATUS FOR AN AUTOMATED MARKETING CAMPAIGN COACH

(71) Applicant: XEROX CORPORATION, Norwalk, CT (US)

(72) Inventors: Michael E. FARRELL, Rochester, NY (US); Stephen Michael Simpson, Victor, NY (US); Warren Kleiman, Penfield, NY (US); Jack T. Latone, Rochester, NY (US); Derrick Kazuo Doi, Webster, NY (US)

(73) Assignee: Xerox Corporation, Norwalk, CT (US)

(21) Appl. No.: 13/626,616

(22) Filed: Sep. 25, 2012

(51) Int. Cl. G06Q 30/02

(52) U.S. Cl. 705/14.45; 705/14.41

(57) ABSTRACT

A method, non-transitory computer readable medium, and apparatus for recommending one or more cross-media marketing campaign strategies are disclosed. For example, the method collects information about a business, applies a weighting table to the information about the business, wherein the weighting table comprises a pre-defined value for each one of a plurality of cross-media marketing campaign strategies based upon a plurality of different industries and a plurality of different business operations, calculates, via a processor, a total score for each one of the plurality of cross-media marketing campaign strategies for an industry and a business operation determined based upon the information about the business that is collected and recommends one or more cross-media marketing campaign strategies based upon the total score of each one of the plurality of cross-media marketing campaign strategies.

The present disclosure relates generally to a solution that helps businesses formulate a marketing strategy and, more particularly, to a method and an apparatus for an automated marketing campaign coach.

### BACKGROUND

Many businesses attempt to use marketing to help promote their business and generate more revenue. Some businesses look for help in determining what marketing strategies to deploy.

Currently, marketing strategies are typically formulated manually by specialized professionals and their services can be extremely expensive. These services may not be affordable for most medium and small sized businesses. As a result, many businesses may be left with an inadequate marketing strategy or no marketing strategy at all.

### SUMMARY

According to aspects illustrated herein, there are provided a method, a non-transitory computer readable medium, and an apparatus for recommending one or more cross-media marketing campaign strategies. One disclosed feature of the embodiments is a method that collects information about a business, applies a weighting table to the information about the business, wherein the weighting table comprises a pre-defined value for each one of a plurality of cross-media marketing campaign strategies based upon a plurality of different industries and a plurality of different business operations, calculates, via a processor, a total score for each one of the plurality of cross-media marketing campaign strategies for an industry and a business operation determined based upon the information about the business that is collected and recommends one or more cross-media marketing campaign strategies based upon the total score of each one of the plurality of cross-media marketing campaign strategies.

Another disclosed feature of the embodiments is a non-transitory computer-readable medium having stored thereon a plurality of instructions which, when executed by a processor, cause the processor to perform a method that collects information about a business, applies a weighting table to the information about the business, wherein the weighting table comprises a pre-defined value for each one of a plurality of cross-media marketing campaign strategies based upon a plurality of different industries and a plurality of different business operations, calculates a total score for each one of the plurality of cross-media marketing campaign strategies for an industry and a business operation determined based upon the information about the business that is collected and recommends one or more cross-media marketing campaign strategies based upon the total score of each one of the plurality of cross-media marketing campaign strategies.

Another disclosed feature of the embodiments is an apparatus comprising a processor that is configured to collect information about a business, apply a weighting table to the information about the business, wherein the weighting table comprises a pre-defined value for each one of a plurality of cross-media marketing campaign strategies based upon a plurality of different industries and a plurality of different business operations, calculate a total score for each one of the plurality of cross-media marketing campaign strategies for an industry and a business operation determined based upon the information about the business that is collected and recommend one or more cross-media marketing campaign strategies based upon the total score of each one of the plurality of cross-media marketing campaign strategies.

### BRIEF DESCRIPTION OF THE DRAWINGS

The teaching of the present disclosure can be readily understood by considering the following detailed description in conjunction with the accompanying drawings, in which:

FIG. 1 illustrates one example of a communication network of the present disclosure;

FIG. 2 illustrates an example of an industry weighting table;

FIG. 3 illustrates an example of a business operation weighting table;

FIG. 4 illustrates an example flowchart of one embodiment of a method for calculating a recommended cross-media marketing campaign strategy; and

FIG. 5 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present disclosure broadly discloses a method and non-transitory computer readable medium for calculating a recommended cross-media marketing campaign strategy. As discussed above, many businesses attempt to use marketing to help promote their business and generate more revenue. Some businesses look for help in determining what marketing strategies to deploy.

Currently, marketing strategies are typically formulated manually by specialized professionals and their services can be extremely expensive. These services may not be affordable for most medium and small sized businesses.

In addition, many of these methods require a small business owner to meet with the professional to formulate the marketing strategy. Many small business owners may not have the manpower or time, especially for sole proprietors, to meet in person for an extended period of time with the professional to formulate a marketing strategy. As a result, many businesses may be left with an inadequate marketing strategy or no marketing strategy at all.

One embodiment of the present disclosure provides an automated marketing campaign coach that allows small and medium sized businesses to independently decide and select a marketing strategy that fits the business and the businesses objectives. In one embodiment, the automated marketing campaign coach provides cross-media marketing strategy recommendations based upon information received about the business. In other words, all of the marketing strategy recommendations provided by the automated marketing campaign coach include at least two different types of media for marketing campaigns.

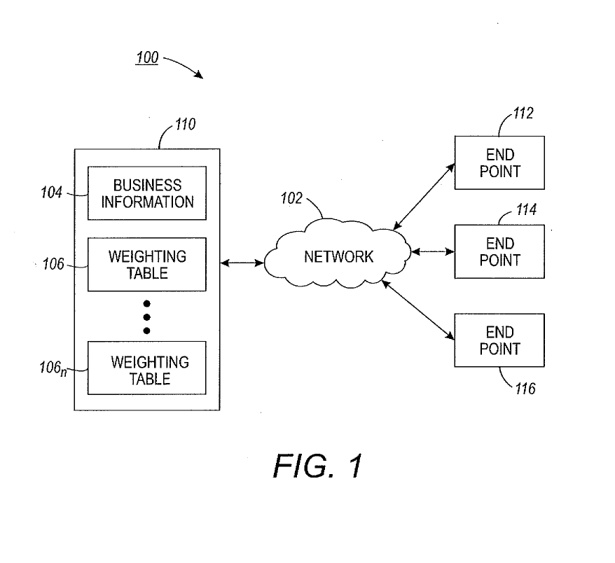

To better understand the present disclosure, FIG. 1 illustrates an example of a communication network 100. In one embodiment, the communication network 100 includes a packet network such as an Internet Protocol (IP) network 102. The IP network 102 may be, for example, the Internet, a service provider network, an access network, a core network, a local area network, and the like.

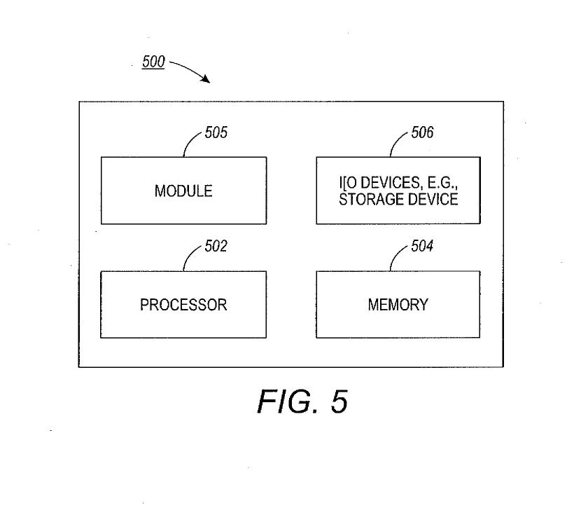

In one embodiment, an automated marketing campaign coach 110 may be in communication with the IP network 102. In one embodiment, the automated marketing campaign coach 110 may include general personal computing capabilities similar to the general computing device described below and illustrated in FIG. 5. In one embodiment, the automated marketing campaign coach 110 may include a storage medium 104 for storing business information, a storage medium 106₁ to 106ₙ for storing one or more weighting tables. As discussed in further detail below, the weighting tables may be used to calculate a total score of a plurality of cross-media marketing campaign strategies to determine which cross-media marketing campaign strategies should be recommended based upon user provided business information.

In one embodiment, the business information may be provided locally by a user. For example, the automated marketing campaign coach 110 may be executed on a general-purpose computer and a user may provide the business information locally. In another embodiment, the automated marketing campaign coach 110 may be centrally located on a server in the communication network 100 and accessed remotely by one or more endpoint devices 112, 114 and 116. For example, a user may access the automated marketing campaign coach 110 on a computer in his or her place of business via a web interface.

The one or more endpoint devices 112, 114 and 116 may be any device capable of communicating with the automated marketing campaign coach 110, such as for example, a personal computer, a lap top computer, a tablet device, a smartphone, a cellular phone, a netbook, and the like. Although three endpoint devices 112, 114 and 116 are illustrated in FIG. 1, it should be noted that any number of endpoint devices may be deployed.

In one embodiment, business information that is collected may include, for example, business assets and/or one or more business objectives for the marketing effort. For example, information about business assets may include customer lists, logos, web sites, customer purchase history, rewards programs, and the like. For example, information about one or more business objectives for the marketing effort may include sales promotion, customer segmentations, new customer acquisition, customer retention, increased revenue, and the like.

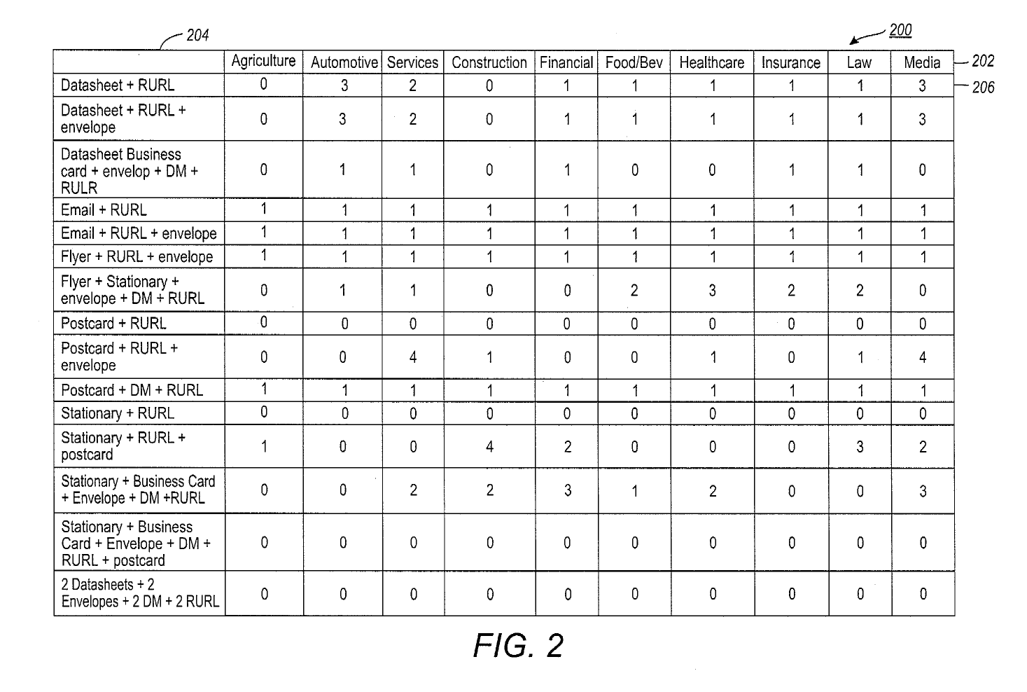

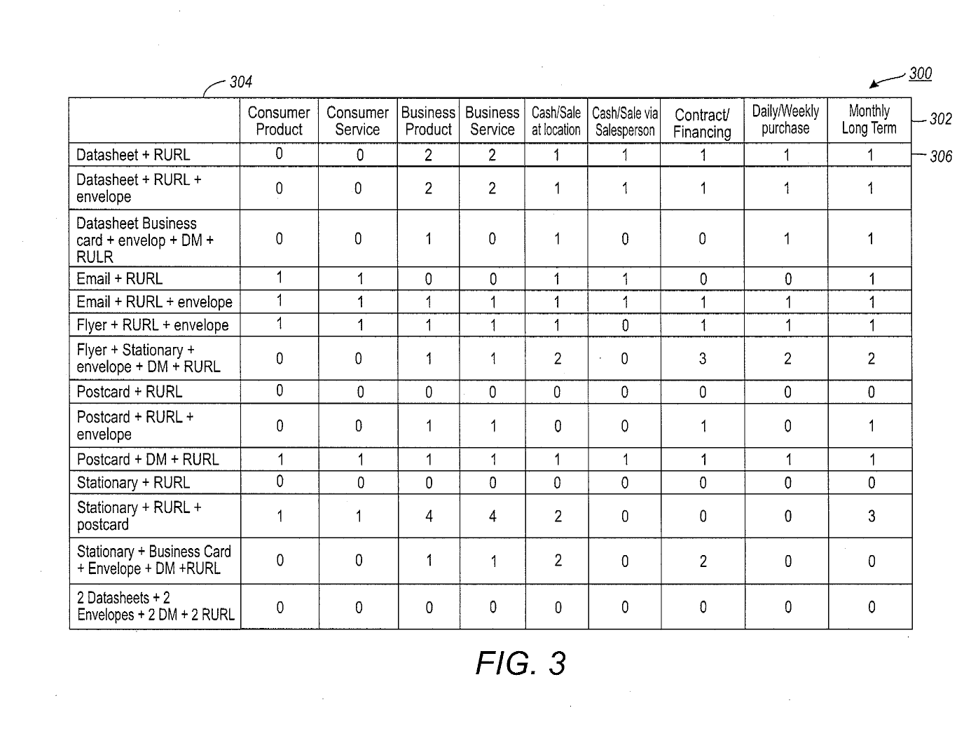

In one embodiment, the weighting tables 106₁ to 106ₙ may include tables such as an industry-weighting table 200 illustrated by example in FIG. 2 and a business operation-weighting table 300 illustrated by example in FIG. 3. FIG. 2 illustrates an example of the industry-weighting table 200. In one embodiment, the industry-weighting table 200 may include a matrix of cells 206 that correlate industry types 202 to a plurality of cross-media marketing campaign strategies 204. Each cell 206 may include a value associated with a particular cross-media marketing campaign strategy 204 to a particular industry type 202.

Some examples of industries 202 include for example, agriculture, automotive, services, construction, financial, food and beverage, healthcare, insurance, law, media, and the like. Although several example industries 202 are provided in FIG. 2, it should be noted that the table 200 may include other industries that are not illustrated in FIG. 2.

Some examples of media used for outbound marketing campaign strategies include, datasheets, response universal resource locators (RURL) or personalized universal resource locators (PURL), also referred to as a landing page, email, business identity media (e.g., business cards, envelopes and stationary), direct mail (DM), flyers, postcards, door hangers, social media, and the like. The cross-media marketing campaign strategies 204 include two or more different marketing campaign strategies listed above. Although several example cross-media marketing campaign strategies 204 are listed in FIG. 2, it should be noted that the table 200 may include other cross-media marketing campaign strategies that are not illustrated in FIG. 2.

In one embodiment, the value may be any number. In one embodiment, positive and negative integers may be used. For example, a positive integer may indicate a positive effect and a negative integer may indicate a negative effect. In one embodiment, only positive integers and zero may be used for simplicity. For example, positive integers may be used to indicate a positive effect and zero may be used for all other effects (e.g., either negative or no effect). In one embodiment, a high value may be interpreted as having a high response rate for a particular cross-media marketing campaign strategy 204 applied to a particular industry 202.

In one embodiment, the industry-weighting table 200 may be a pre-defined. The values in each cell 206 may be based upon one or more factors including, for example, historical response rates, complexity of the cross-media marketing campaign strategy and/or a cost to deploy the cross-media marketing campaign strategy. In one embodiment, the initial values may be pre-defined by a subject matter expert that populates the value for each cell 206 based upon the above factors.

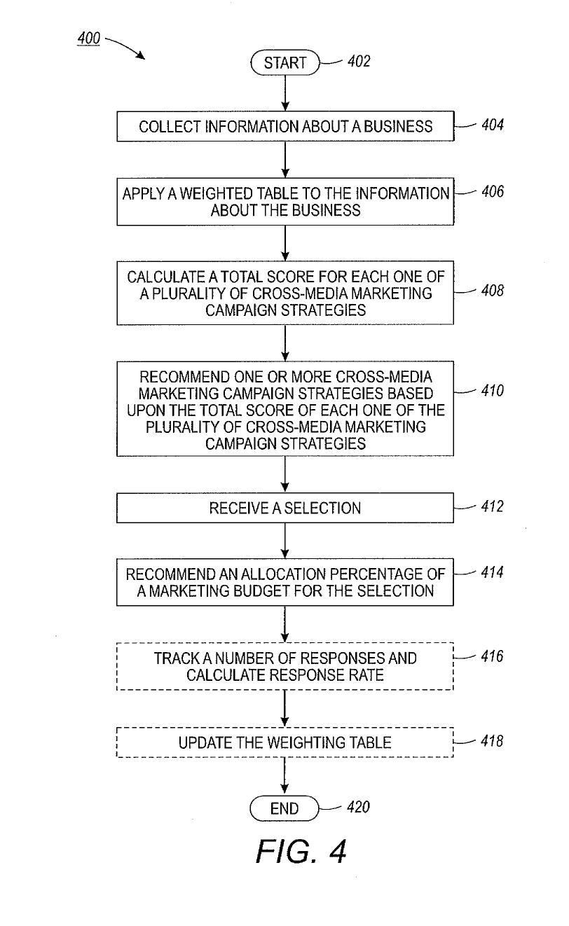

In one embodiment, after the industry-weighting table 200 is initially set, the values in each cell 206 of the industry-weighting table 200 may be updated over time. This process is discussed in further detail below referring to FIG. 4.

FIG. 3 illustrates an example of the business operation-weighting table 300. In one embodiment, the business operation-weighting table 300 may include a matrix of cells 306 that correlate business operation types 302 to a plurality of cross-media marketing campaign strategies 304. Each cell 306 may include a value associated with a particular cross-media marketing campaign strategy 304 to a particular business operation 302.

Some examples of business operations 302 include for example, selling consumer products, selling consumer services, selling a business product, selling a business service, having a cash sale at a business location, having a cash sale via a salesperson, contract/financing sales, daily/weekly purchase sales, monthly/long term purchase sales, and the like. Although several example business operations 302 are provided in FIG. 3, it should be noted that the table 300 may include other types of business operations that are not illustrated in FIG. 3. In one embodiment, a business operation may fall into multiple categories of the business operations. For example, the business may be a consumer product company that has cash sales at the business location or store.

Some examples of media used for marketing campaign strategies include, datasheets, RURL or PURL, also referred to as a landing page, email, business identity media (e.g., business cards, envelopes and stationary), DM, flyers, postcards, door hangers, social media, and the like. The cross-media marketing campaign strategies 304 include two or more different marketing campaign strategies listed above. Although several example cross-media marketing campaign strategies 304 are listed in FIG. 3, it should be noted that the table 300 may include other cross-media marketing campaign strategies that are not illustrated in FIG. 3.

In one embodiment, the value may be any number. In one embodiment, positive and negative integers may be used. For example, a positive integer may indicate a positive effect and a negative integer may indicate a negative effect. In one embodiment, only positive integers and zero may be used for simplicity. For example, positive integers may be used to indicate a positive effect and zero may be used for all other effects (e.g., either negative or no effect). In one embodiment, a high value may be interpreted as having a high response rate for a particular cross-media marketing campaign strategy 304 applied to a particular business operation 304.

In one embodiment, the business operation-weighting table 300 may be a pre-defined. The values in each cell 306 may be based upon one or more factors including, for example, historical response rates, complexity of the cross-media marketing campaign strategy and/or a cost to deploy the cross-media marketing campaign strategy. In one embodiment, the initial values may be pre-defined by a subject matter expert that populates the value for each cell 306 based upon the above factors.

In one embodiment, after the business operation weighting table 300 is initially set, the values in each cell 306 of the business operation weighting table 300 may be updated over time. This process is discussed in further detail below referring to FIG. 4.

Although an industry weighting table 200 and a business operation weighting table 300 is used, it should be noted that any other types of tables that take into consideration other business factors may also be used to apply a weighting. For example, other types of weighting tables may include program weighting applied to tactics, a business description weighting table, and the like. The provided tables and values within the tables are only examples.

In one embodiment, the business information 104, the industry weighting table 200 and the business operation weighting table 300 may be used to calculate a total score for each one of the plurality of cross-media marketing campaign strategies. For example, the automated marketing campaign coach 110 may determine that a business has no customer mailing address list, and is an automotive parts company that sells parts to consumers. The automated marketing campaign coach 110 may then determine an automotive industry weight value for each one of the cross-media marketing campaign strategies from table 200 and a consumer product business operation weight value and a cash/sale at location business operation weight value for each one of the cross-media marketing campaign strategies. The automated marketing campaign coach 110 may add the values together to obtain a total score.

In one embodiment, the automated marketing campaign coach 110 would automatically eliminate some of the cross-media marketing campaign strategies based upon the business information that is received. In the above example, the business has no customer mailing address list. As a result, direct mail would not be an option. Thus, any cross-media marketing campaign strategy that includes direct mail would be removed as a possible option.

In one embodiment, the automated marketing campaign coach 110 may provide a recommended cross-media marketing campaign strategy to the user based upon the highest total score. In one embodiment, the top three highest scoring cross-media marketing campaign strategies may be provided as recommendations.

Using the above example and based upon the table 200 and the table 300, the highest total scoring cross-media marketing campaign strategies would be a datasheet+RURL cross-media marketing campaign strategy or a datasheet+RURL+envelope cross-media marketing campaign strategy each having a total score of 4. In one embodiment, once the user selects a cross-media marketing campaign strategy from the recommended cross-media marketing campaign strategies, the automated marketing campaign coach 110 may also provide a recommended allocation percentage for each type of media marketing strategy based upon a predefined marketing budget.

In one embodiment, the recommended allocation percentage may be based upon a cost of the type of media marketing strategy, an expected response rate of type of media marketing strategy, an expected return on investment (ROI) and one or more business objectives. For example, using the above example, if the datasheet is relatively inexpensive, has an average response rate and the business objective is to promote sales at a minimal cost, then the datasheet may be allocated a larger percentage of the marketing budget. The RURL may be allocated a second smaller percentage than the datasheet based on more expensive cost, even though it may have a slightly higher expected response rate. The envelope may be allocated the smallest percentage based on the highest cost and possibly equal response rate as the datasheet.

In one embodiment, once the cross-media marketing campaign strategy is selected and deployed, the automated marketing campaign coach 110 may track or monitor the response and calculate a response rate for each one of the types of media marketing strategies of the selected cross-media marketing campaign strategy. In one embodiment, the responses may be tracked by receiving input manually from the business owner or user. In another embodiment, the responses may be automatically tracked over the IP network 102 if the type of media marketing strategy is a RURL or a PURL. With the latest response rates, the automated marketing campaign coach 110 may then update the values of the cells 206 and 306 in the tables 200 and 300, respectively.

It should be noted that the network 100 has been simplified for clarity. For example, the network 100 may include other network elements such as border elements, routers, switches, policy servers, security devices, firewalls, a content distribution network (CDN) and the like. In addition, the network 100 may include additional networks between the endpoint devices and the IP network 102 such as different access networks (e.g., a wired access network, a cable network, a wireless network, a cellular network, a Wi-Fi network, and the like) to reach the IP network 102.

FIG. 4 illustrates a flowchart of a method 400 for calculating a recommended cross-media marketing campaign strategy. In one embodiment, the method 400 may be performed by the automated marketing campaign coach 110 or a general-purpose computer as illustrated in FIG. 5 and discussed below.

The method 400 begins at step 402. At step 404, the method 400 collects information about a business. In one embodiment, business information may include business assets and/or one or more business objectives for the marketing effort. For example, information about business assets may include customer lists, logos, web sites, customer purchase history, rewards programs, and the like. For example, information about one or more business objectives for the marketing effort may include sales promotion, customer segmentations, new customer acquisition, customer retention, increased revenue, and the like.

At step 406, the method 400 applies a weighting table to the information about the business. In one embodiment, the weighting table may comprise a pre-defined value for each one of a plurality of cross-media marketing campaign strategies based upon a plurality of different industries and a plurality of different business operations. An example of an industry-weighting table is illustrated in FIG. 2 and an example of a business operation-weighting table is illustrated in FIG. 3.

Although an industry weighting table and a business operation weighting table is used, it should be noted that any other types of tables that take into consideration other business factors may also be used to apply a weighting. For example, other types of weighting tables may include program weighting applied to tactics, a business description weighting table, and the like. The provided tables and values within the tables are only examples.

At step 408, the method 400 calculates a total score for each one of the plurality of cross-media marketing campaign strategies for an industry and a business operation determined based upon the information about the business that is collected. For example, using the collected business information, an industry type and a business operation type may be obtained. The value for each one of the plurality of cross-media marketing campaign strategies corresponding to the industry type and the business operation may be determined based upon the industry weighting table and the business operation weighting table, respectively. The values may be added for each one of the plurality of cross-media marketing campaign strategies to calculate the total score.

At step 410, the method 400 recommends one or more cross-media marketing campaign strategies based upon the total score of each one of the plurality of cross-media marketing campaign strategies. In one embodiment, the method 400 may recommend the top three cross-media marketing campaign strategies with the highest total scores.

In one embodiment, some cross-media marketing campaign strategies may be filtered out based upon the business information that is collected. For example, if the business has no customer mailing address list, then any cross-media marketing campaign strategy with direct mailing may be eliminated as a possible recommendation even if it has one of the highest scores.

At step 412, the method 400 receives a selection of one of the one or more cross-media marketing campaign strategies that are recommended. For example, a user or a business owner may select one of the recommended cross-media marketing campaign strategies that are presented.

In one embodiment, the automated marketing campaign coach may be configured to operate with a marketing campaign wizard. The marketing campaign wizard may be an automated system that helps a user or business owner to create each one of the different types of media marketing strategies in the selected cross-media marketing campaign strategy that is selected. For example, templates may be provided that the user may easily populate with his or her business information and/or the appropriate promotion.

At step 414, the method 400 recommends an allocation percentage of a marketing budget for each type of media marketing strategy of the cross-media marketing campaign strategy that is selected. In one embodiment, the recommended allocation percentage may be based upon a cost of the type of media marketing strategy, an expected response rate of type of media marketing strategy, an expected ROI and one or more business objectives. For example, assume the selected cross-media marketing campaign strategy includes a datasheet, a RURL and an envelope. If the datasheet is relatively inexpensive, has an average response rate and the business objective is to promote sales at a minimal cost, then the datasheet may be allocated a larger percentage of the marketing budget. The RURL may be allocated a second smaller percentage than the datasheet based on more expensive cost, even though it may have a slightly higher expected response rate. The envelope may be allocated the smallest percentage based on the highest cost and possibly equal response rate as the datasheet.

At optional step 416, the method 400 may track a number of responses to a selected cross-media marketing campaign strategy that is selected from the one or more cross-media marketing campaign strategies that are recommended and calculate a response rate for the selected cross-media marketing campaign strategy. In one embodiment, the responses may be tracked by receiving input manually from the business owner or user. In another embodiment, the responses may be automatically tracked over the Internet or an IP network if the type of media marketing strategy is a RURL or a PURL.

In one embodiment, the tracking may also correlate the type of visual designs that are used and the type of mail services that are used. For example, the method 400 may determine which designs are most effective, whether first class mail is better than standard mail, whether addressed mail is better than Every Door Direct Mail® service, and the like. This information may be considered when updating the various weighting tables.

At optional step 418, the method 400 may update the weighting table for the selected cross-media marketing campaign strategy. In other words, the values in the weighting tables may be dynamic after they are initially set. As more information is collected about the response rates and effectiveness of each one of the plurality of cross-media marketing campaign strategies, the values may be increased or lowered accordingly. The method ends at step 420.

It should be noted that although not explicitly specified, one or more steps, blocks or operations of the method 400 described above may include a storing, displaying and/or outputting step as required for a particular application. In other words, any data, records, fields, and/or intermediate results discussed in the methods can be stored, displayed, and/or outputted to another device as required for a particular application. Furthermore, steps, blocks or operations in FIG. 4 that recite a determining operation, or involve a decision, do not necessarily require that both branches of the determining operation be practiced. In other words, one of the branches of the determining operation can be deemed as an optional step.

FIG. 5 depicts a high-level block diagram of a general-purpose computer suitable for use in performing the functions described herein. As depicted in FIG. 5, the system 500 comprises a hardware processor element 502 (e.g., a microprocessor, a central processing unit (CPU) and the like), a memory 504, e.g., random access memory (RAM) and/or read only memory (ROM), a module 505 for calculating a recommended cross-media marketing campaign strategy, and various input/output devices 506 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present disclosure can be implemented in software and/or in a combination of software and hardware, e.g., using application specific integrated circuits (ASIC), a general purpose computer or any other hardware equivalents, e.g., computer readable instructions pertaining to the method(s) discussed above can be used to configure a hardware processor to perform the steps of the above disclosed methods. In one embodiment, the present module or process 505 for calculating a recommended cross-media marketing campaign strategy can be loaded into memory 504 and executed by processor 502 to implement the functions as discussed above. As such, the present method 505 for calculating a recommended cross-media marketing campaign strategy (including associated data structures) of the present disclosure can be stored on a non-transitory (e.g., physical and tangible) computer readable storage medium, e.g., RAM memory, magnetic or optical drive or diskette and the like. For example, the hardware processor 502 can be programmed or configured with instructions (e.g., a software program comprising computer-executable instructions) to perform the steps or operations of method 400.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A method for recommending one or more cross-media marketing campaign strategies, comprising:
collecting information about a business;
applying a weighting table to the information about the business, wherein the weighting table comprises a pre-defined value for each one of a plurality of cross-media marketing campaign strategies based upon a plurality of different industries and a plurality of different business operations;
calculating, via a processor, a total score for each one of the plurality of cross-media marketing campaign strategies for an industry and a business operation determined based upon the information about the business that is collected; and
recommending the one or more cross-media marketing campaign strategies based upon the total score of each one of the plurality of cross-media marketing campaign strategies.

2. The method of claim 1, wherein each one of the plurality of cross-media marketing campaign strategies comprises two or more different types of media marketing campaign strategies.

3. The method of claim 2, wherein the two or more different types of media marketing campaign strategies are selected from a group comprising: a datasheet, a response universal resource locator (RURL), a flyer, an email, a direct mailing, a business identity media, a door hanger, social media or a postcard.

4. The method of claim 1, wherein the information about the business comprises an industry of the business, a business operation of the business and one or more business objectives.

5. The method of claim 1, further comprising:
receiving a selection of one of the one or more cross-media marketing campaign strategies that are recommended; and
recommending an allocation percentage of a marketing budget for each type of media marketing strategy of the cross-media marketing campaign strategy that is selected.

6. The method of claim 5, wherein the allocation percentage is determined based upon a cost of the type of media marketing strategy, an expected response rate of the type of media marketing strategy and a business objective.

7. The method of claim 1, further comprising:
tracking a number of responses to a selected cross-media marketing campaign strategy that is selected from the one or more cross-media marketing campaign strategies that are recommended;
calculating a response rate for the selected cross-media marketing campaign strategy; and
updating the weighting table for the selected cross-media marketing campaign strategy.

8. The method of claim 1, wherein the weighting table assigns a value based upon at least one of: a complexity of each one of the plurality of cross-media marketing strategies, a cost of each one of the plurality of cross-media marketing strategies or an expected response rate of each one of the plurality of cross-media marketing strategies.

9. The method of claim 1, wherein the calculating comprises:
determining an industry weight value of each one of the plurality of cross-media marketing campaign strategies based upon an industry weighting table for the industry of the business;
determining a business operation weight value of each one of the plurality of cross-media marketing campaign strategies based upon a business operation weighting table for the business operation of the business; and
adding the industry weight value and the business operation weight value to calculate the total score.

10. A non-transitory computer-readable medium having stored thereon a plurality of instructions which, when executed by a processor, cause the processor to perform operations for recommending one or more cross-media marketing campaign strategies, the operations comprising:
collecting information about a business;
applying a weighting table to the information about the business, wherein the weighting comprises a pre-defined value for each one of a plurality of cross-media marketing campaign strategies based upon a plurality of different industries and a plurality of different business operations;
calculating a total score for each one of the plurality of cross-media marketing campaign strategies for an industry and a business operation determined based upon the information about the business that is collected; and
recommending the one or more cross-media marketing campaign strategies based upon the total score of each one of the plurality of cross-media marketing campaign strategies.

11. The non-transitory computer-readable medium of claim 10, wherein each one of the plurality of cross-media marketing campaign strategies comprises two or more different types of media marketing campaign strategies.

12. The non-transitory computer-readable medium of claim 11, wherein the two or more different types of media marketing campaign strategies are selected from a group comprising: a datasheet, a response universal resource locator (RURL), a flyer, an email, a direct mailing, a business identity media, a door hanger, social media or a postcard.

13. The non-transitory computer-readable medium of claim 10, wherein the information about the business comprises an industry of the business, a business operation of the business and one or more business objectives.

14. The non-transitory computer-readable medium of claim 10, further comprising:
receiving a selection of one of the one or more cross-media marketing campaign strategies that are recommended; and
recommending an allocation percentage of a marketing budget for each type of media marketing strategy of the cross-media marketing campaign strategy that is selected.

15. The non-transitory computer-readable medium of claim 14, wherein the allocation percentage is determined based upon a cost of the type of media marketing strategy, an expected response rate of the type of media marketing strategy and a business objective.

16. The non-transitory computer-readable medium of claim 10, further comprising:
tracking a number of responses to a selected cross-media marketing campaign strategy that is selected from the one or more cross-media marketing campaign strategies that are recommended;
calculating a response rate for the selected cross-media marketing campaign strategy; and
updating the weighting table for the selected cross-media marketing campaign strategy.

17. The non-transitory computer-readable medium of claim 10, wherein the weighting table assigns a value based upon at least one of: a complexity of each one of the plurality of cross-media marketing strategies, a cost of each one of the plurality of cross-media marketing strategies or an expected response rate of each one of the plurality of cross-media marketing strategies.

18. The non-transitory computer-readable medium of claim 10, wherein the calculating comprises:
determining an industry weight value of each one of the plurality of cross-media marketing campaign strategies based upon an industry weighting table for the industry of the business;
determining a business operation weight value of each one of the plurality of cross-media marketing campaign strategies based upon a business operation weighting table for the business operation of the business; and
adding the industry weight value and the business operation weight value to calculate the total score.

19. A method for recommending one or more cross-media marketing campaign strategies, comprising:
collecting information about a business comprising an industry of the business, a business operation of the business and one or more business objectives;
determining an industry weight value of each one of a plurality of cross-media marketing campaign strategies based upon an industry weighting table for the industry of the business;
determining a business operation weight value of each one of the plurality of cross-media marketing campaign strategies based upon a business operation weighting table for the business operation of the business;
adding, via a processor, the industry weight value and the business operation weight value to calculate a total score for each one of the plurality of cross-media marketing campaign strategies;
recommending the one or more cross-media marketing campaign strategies based upon the total score of each one of the plurality of cross-media marketing campaign strategies;
receiving a selection of one of the one or more cross-media marketing campaign strategies that are recommended;
recommending an allocation percentage of a marketing budget for each type of media marketing strategy of the one of the one or more cross-media marketing campaign strategies that is selected;
tracking a number of responses to a selected cross-media marketing campaign strategy that is selected from the one or more cross-media marketing campaign strategies that were recommended;
calculating a response rate for the selected cross-media marketing campaign strategy; and
updating the weighting table for the selected cross-media marketing campaign strategy.

20. The method of claim 19, wherein each one of the plurality of cross-media marketing campaign strategies comprises two or more different types of media marketing campaign strategies.
